(19) United States
(12) Patent Application Publication
(10) Pub. No.: US 2009/0033286 A1
(43) Pub. Date: Feb. 5, 2009

(54) Cell and Supercapacitor Battery Pack

(76) Inventors: Dean La Rosa, Bohemia, NY (US); Michael T. Verdecanna, Bayport, NY (US)

Correspondence Address: Fay Kaplun & Marcin, LLP/ Motorola, 150 Broadway Suite 702, New York, NY, 10038, US

(21) Appl. No.: 11/831,188

(22) Filed: Jul. 31, 2007

(51) Int. Cl. H02J 7/00

(52) U.S. Cl. 320/135

(57) ABSTRACT

Described is a battery pack including a housing and at least one cell disposed in the housing to provide power to an electronic device. The battery pack also includes a supercapacitor disposed in the housing to provide additional power to the electronic device.

### FIELD OF THE INVENTION

The present invention relates generally to a battery pack that includes cells and a supercapacitor.

### BACKGROUND

A mobile device includes a battery to allow a user to utilize the mobile device without a permanent connection to a separate power supply. The battery includes a maximum amount of current that may be discharged to power the various components of the mobile device. Depending on the components that are used, the duration that the components are used, and the purpose for which the components are used, the battery may discharge at different rates. For example, when attempting to connect to a wireless network, the wireless radio of the mobile device may require a relatively high amount of current. Furthermore, this high amount of current may be necessary for very short periods of time. The drain placed on the battery may not allow the user to utilize the mobile device for much longer once the mobile device has connected to the wireless network.

### SUMMARY OF THE INVENTION

The present invention relates to a battery pack including a housing and at least one cell disposed in the housing to provide power to an electronic device. The battery pack also includes a supercapacitor disposed in the housing to provide additional power to the electronic device.

The present invention also relates to a system including an electronic device including a recess and a battery pack to be received in the recess. The battery pack includes a housing that houses at least one cell that provides power to the electronic device and a supercapacitor that provides additional power to the electronic device.

The present invention also relates to a battery pack including a housing and a first power supplying means for providing power to an electronic device. The battery pack also includes a second power supplying means for providing additional power to the electronic device, the first and second power supplying means being disposed in the housing.

### DESCRIPTION OF THE DRAWINGS

FIG. 1 shows an inside view of a battery pack according to an exemplary embodiment of the present invention.

FIG. 2 shows a perspective view of the battery pack of FIG. 1.

FIG. 3 shows an inside view of an electronic device according to an exemplary embodiment of the present invention that receives the battery pack of FIG. 1.

FIG. 4 shows a perspective view of the electronic device of FIG. 3.

FIG. 5 shows an assembled view of the electronic device of FIG. 3 upon receiving the battery pack of FIG. 1.

### DETAILED DESCRIPTION

The present invention may be further understood with reference to the following description and the appended drawings, wherein like elements are referred to with the same reference numerals. The exemplary embodiments of the present invention describe a battery pack that includes cells and a supercapacitor (supercap). According to the exemplary embodiments of the present invention, the battery pack may house the cells and the supercap within a common housing but may isolate the supercap from the cells. Respective contacts may provide an electrical connection to an electronic device (e.g., personal computer, laptop, pager, mobile device, cell phone, radio frequency identification device, scanner, a data acquisition device, an imager, etc.). The cells, supercap, and contacts will be discussed in more detail below.

To alleviate the high discharge of current on the battery, a mobile device may include a supercap that provides additional current. This additional current may be used for specific processes such as connecting to a wireless network. The supercap may be placed directly on a printed circuit board (PCB) of the mobile device to keep the supercap as close as possible to the wireless radio to minimize trace impedance losses. However, if the supercap is placed within the electronic device, it occupies a portion of the space within the electronic device and increases the overall size of the electronic device.

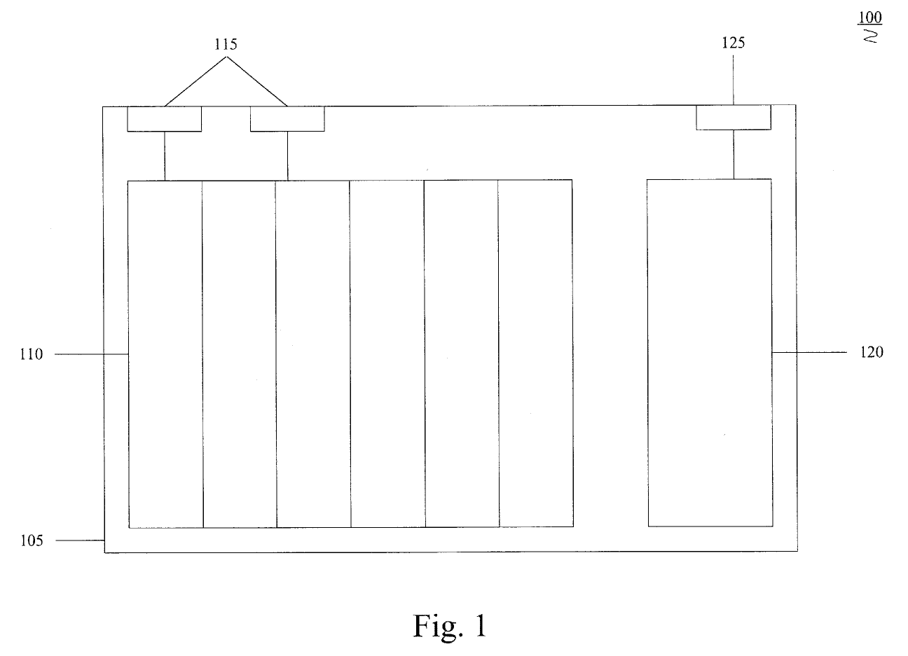

FIG. 1 shows an inside view of a battery pack 100 according to an exemplary embodiment of the present invention. The battery pack 100 may be used to power any electronic device such as those listed above. The battery pack 100 may be a rechargeable battery such as nickel cadmium, nickel hydride, lithium ion (LiIon), etc. However, it should be noted that the battery pack 100 may also be non-rechargeable (e.g., one use). The battery pack 100 may include a battery housing 105, cells 110, cell contacts 115, a supercap 120, and a supercap contact 125.

The battery housing 105 may provide a casing in which the components of the battery pack 100 are wholly or at least partially disposed within the battery housing 105. For example, the cells 110 and the supercap 120 may be wholly disposed within the battery housing 105 while the cell contacts 115 and the supercap contact 125 may be partially disposed within the battery housing 105. The battery housing 105 may also allow stickers stating specifications (e.g., voltage, capacity, serial number, etc.) of the battery pack 100 to be disposed on the outer periphery.

The cells 110 may be electrochemical cells that store chemical energy. Those skilled in the art will understand that a battery may include a single cell or, alternatively, may include at least two cells connected in series to provide power to an electronic device. The cells 110 may be conventional cells found in conventional batteries. For example, the cells 110 may be Li-Ion cells, nickel cadmium cells, nickel hydride cells, etc. As shown, the battery pack 100 includes six cells 110. However, it should be noted that the battery pack may include as few as one cell and may include more than six cells. The cells 110 may be rechargeable and may be recharged using any conventional methods. For example, the battery pack 100 may be placed in a cradle that may be connected to a power supply. The cradle may be equipped with a charger to recharge the cells 110.

The cell contacts 115 may be electrically connected to the cells 110. The cell contacts 115 may provide an electrical coupling to a corresponding set of contacts so that an electronic device may be powered from the energy stored in the cells 110. As illustrated in FIG. 1, the cell contacts 115 may be flat heads manufactured with a conducting material such as copper, silver, gold, etc. It should be noted that the use of flat heads for the cell contacts 115 is only exemplary. Those skilled in the art will understand that the cell contacts 115 may exhibit other shapes. For example, the cell contacts 115 may be pins. In another example, the cell contacts 115 may be hemi-spherical. In yet another example, the cell contacts 115 may be spring contacts. The pins, hemi-spherical extensions, and the spring contacts may be manufactured using substantially similar conducting material as described above with the flat heads. The cell contacts 115 may be in direct contact with corresponding cell contacts of an electronic device (e.g., the cell contacts 115 may extend beyond the periphery of the housing 105). Alternatively, in other embodiments, the cell contacts 115 may not extend beyond the periphery of the housing 105, but rather, may be separated from the cell contacts of the electronic device by a safety circuit and/or one or more intermediate contacts.

It should be noted that the use of two cell contacts 115 is only exemplary. The cells 110 may be electrically connected to further cell contacts. For example, each cell of the cells 110 may be electrically connected to a pair of cell contacts (e.g., positive terminal and a negative terminal). In another example, a couple (e.g., 2 or 3) cells may be grouped and the group may be electrically connected to a cell contact.

The supercap 120 may be an electrochemical capacitor having a high energy density in comparison to conventional capacitors. The supercap 120 may be utilized in a variety of applications. Often, the supercap 120 may provide energy for applications that require a relatively high amount of initial power such as when a mobile unit attempts a connection to a wireless network. It should be noted that the use of a single supercap 120 is only exemplary. The exemplary embodiments of the present invention may incorporate multiple supercaps disposed within the battery housing 105 of the battery pack 100. The supercap 120 may be rechargeable and may be recharged using any conventional methods. For example, the battery pack 100 may be placed in a cradle that may be connected to a power supply. The cradle may be equipped with a charger to recharge the supercap 120. Those skilled in the art will understand that the charger may be modified or a different charger from the cell charger may be used to recharge the supercap 120 due to the differences between the cells 110 and the supercap 120. For example, a provision may exist to limit a current when charging the supercap 120 when completely discharged.

The supercap contact 125 may be electrically connected to the supercap 120. The supercap contact 125 may provide an electrical coupling to a corresponding set of contacts so that an electronic device may be powered from the energy stored in the supercap 120. As illustrated in FIG. 1, similar to the cell contacts 115, the supercap contact 125 may also be flat heads manufactured with a conducting material such as copper, silver, gold, etc. Also similar to the cell contacts 115, the supercap contact 125 may exhibit other shapes such as pins extending beyond the periphery of the housing 105 and hemi-spherical extensions from the periphery of the housing 105. It should be noted that the illustration of a single supercap contact 125 is only exemplary. The supercap 120 may be electrically connected to further supercap contacts. For example, if multiple supercaps are disposed within the battery pack 100, a respective supercap contact may be electrically connected to each supercap.

According to the exemplary embodiments of the present invention, the cells 110 and the supercap 120 may be electrically isolated from each other. Consequently, the cells 110 and the supercap 120 may separately provide power from the energy stored therein. Therefore, depending on a type of application to be executed by an electronic device, the appropriate power supply (e.g., the cells 110 or the supercap 120) may be utilized. It should be noted that the cells 110 and the supercap 120 providing power individually may embody various different configurations. For example, only the cells 110 may be used for a first set of applications while only the supercap 120 may be used for a second set of applications. In another example, the cells 110 and the supercap 120 may both provide power simultaneously to an application. In yet another example, the cells 110 may initially provide power whereupon the supercap 120 may be used to provide an additional amount of power.

It should also be noted that the cells 110 and the supercap 120 may be disposed as separate power supplies. That is, the cells 110 and the supercap 120 may not share a common stored energy that may be provided to the electronic device. As such, a physical divider may be disposed between the cells 110 and the supercap 120 to electrically separate the cells 110 from the supercap 120. The divider may be a manufactured of a non-conductive material such as a polymer. The divider may also be manufactured of a common material as the battery housing 105.

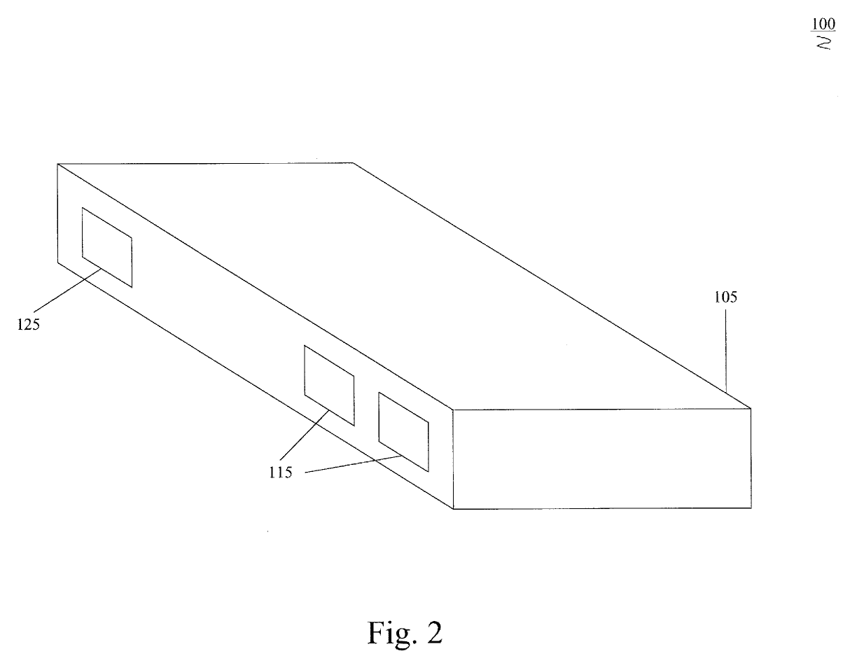

FIG. 2 shows a perspective view of the battery pack 100 of FIG. 1. The perspective view of the battery pack 100 illustrates a peripheral side of the battery pack 100 including the cell contacts 115 and the supercap contact 125. In particular, the perspective view of FIG. 2 illustrates that the cells 110 and the supercap 120 may be wholly disposed within the battery housing 105 while the cell contacts 115 and the supercap contact 125 may be partially disposed within the battery housing 105. The cell contacts 115 and the supercap contact 125 may be located on opposite ends of the peripheral side. The distance between the cell contacts 115 and the supercap contact 125 may also serve as the electrical and/or physical separation between the cells 110 and the supercap 120. It should be noted that the cell contacts 115 and the supercap contact 125 being disposed on a common peripheral side of the battery housing 105 is only exemplary. Depending on the location of the corresponding contacts of the electronic device, the cell contacts 115 and the supercap contact 125 may be disposed on different sides. Furthermore, the cell contacts 115 may be disposed on multiple sides. The supercap contact 125 may also be disposed on multiple sides if multiple supercap contacts existed.

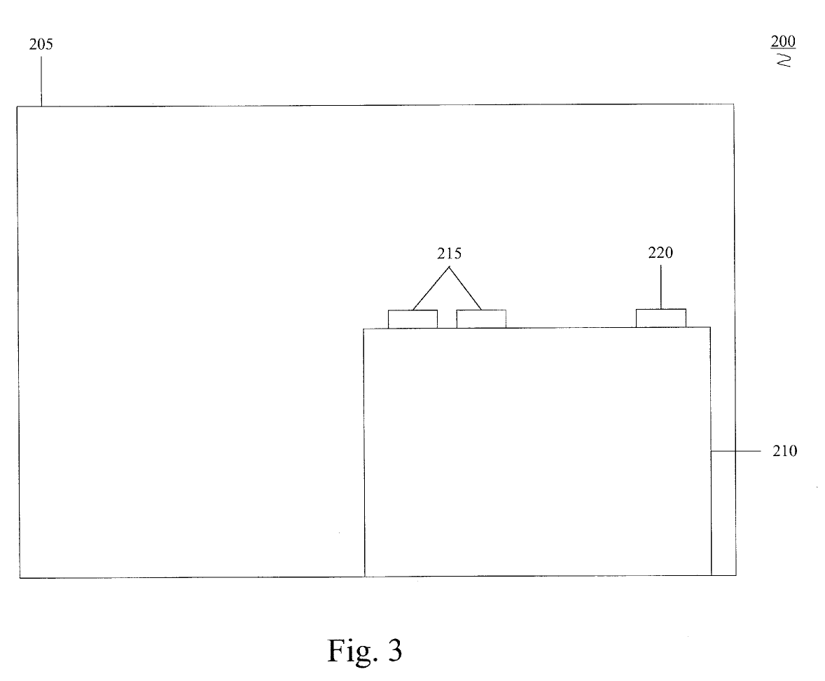

FIG. 3 shows an inside view of an electronic device 200 according to an exemplary embodiment of the present invention that receives the battery pack 100 of FIG. 1. The electronic device 200 may be any device that requires power to utilize at least one component. For example, the electronic device 200 may be a mobile unit. Those skilled in the art will understand that the mobile unit requires a battery such as the battery pack 100 to supply power to operate, for example, a processor. The electronic device 200 may include a device housing 205, a recess 210, corresponding cell contacts 215, and a corresponding supercap contact 220.

The device housing 205 may provide a casing in which the components of the electronic device 200 are wholly or at least partially disposed within the device housing 205. For example, the electronic device may include other components (not shown) such as a processor, a memory, a display, a data input arrangement, a transceiver, an antenna, etc. The processor, the memory, and the transceiver may be wholly disposed within the device housing 205. The display, the data input arrangement, and the antenna may be partially disposed within the device housing 205. The device housing 205 may be manufactured with substantially similar materials used for the battery housing 105.

The device housing 205 may include the recess 210. The recess 210 may serve to receive the battery pack 100. As illustrated in the exemplary embodiment, the recess 210 may be partially disposed within the device housing 205. That is, the recess 210 may include at least one face that creates a window on the device housing 205. The window may be an opening in which the battery pack 100 may be inserted to be received by the recess 210 of the electronic device 200. Those skilled in the art will understand that the recess 210 may take any form in order to receive the battery pack 100.

The corresponding cell contacts 215 and the supercap contact 220 may be disposed on a surface of the recess 210 (i.e., a periphery of the housing 205 coinciding with a side of the recess). According to the exemplary embodiment, the corresponding cell contacts 215 and the supercap contact 220 may be disposed toward a middle of the electronic device 200 such as a far side that is substantially parallel to the window. However, it should be noted that the corresponding cell contacts 215 and the supercap contact 220 may be disposed on various other locations on the recess 210. For example, the corresponding cell contacts 215 and the corresponding supercap contact 220 may be disposed on a side face of the recess 210 that runs perpendicular to the window, on a flat face of the recess 210 that runs perpendicular to the window. Furthermore, it should be noted that the corresponding cell contacts 215 and the corresponding supercap contact 220 may be disposed on multiple sides of the recess 210.

The corresponding cell contacts 215 and the corresponding supercap contact 220 may be designed with respect to the cell contacts 115 and the supercap contact 125. For example, if the cell contacts 115 and the supercap contact 125 are flat heads or spring contacts, then the corresponding cell contacts 215 and the corresponding supercap contact 220 may be flat heads. In another example, if the cell contacts 115 and the supercap contact 125 are pins extending out of the periphery of the battery housing 105, the corresponding cell contacts 215 and the corresponding supercap contact 220 may be pin holes. In yet another example, if the cell contacts 115 and the supercap contact 125 are hemi-spherical extensions beyond the periphery of the battery housing 105, the corresponding cell contacts 215 and the corresponding supercap contact 220 may be concave hemi-spherical indentations.

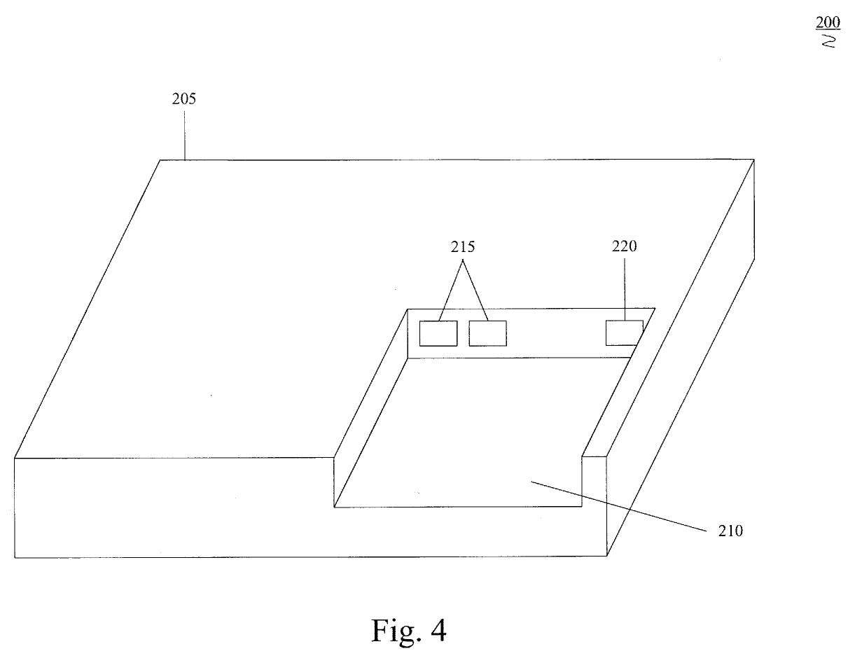

FIG. 4 shows a perspective view of the electronic device 200 of FIG. 3. The perspective view of the electronic device 200 further illustrates the dimensions of the recess 210. As described above, the recess 210 may include a window in which the battery pack 100 may be inserted to be received therein. According to the exemplary embodiment, the recess 210 may include a two-sided window. That is, the recess 210 may occupy a space that creates a gap on two sides of the device housing 205. As illustrated, the corresponding cell contacts 215 and the corresponding supercap contact 220 may be disposed on the inner side of the recess 210.

It should be noted that the use of a two-sided window is only exemplary. For example, the recess 210 may include a one-sided window, thereby creating a slot in which the battery pack 100 may be inserted into the recess 210. In another example, the recess 210 may be disposed wholly within the device housing 205. That is, the device housing 205 may be equipped to be separated to access the recess 210. In yet another example, the battery pack 100 may be externally connected to the electronic device 205 using a connector. The recess 210 may be part of the external power conduit and wholly disposed therein, partially disposed with a window, etc.

The battery pack 100 may include rails disposed on the battery housing 105 to facilitate an inserting of the battery pack 100. The electronic device 200 may include corresponding channels disposed within the recess 210 to receive the rails. Other facilitating mechanisms that allow an efficient and easy manner of placing the battery pack 100 into a proper orientation with the electronic device 200 may be used. In addition, locking mechanisms may be disposed to securely hold the battery pack 100 in the recess 210. The locking mechanisms may be mechanical. For example, one or more recesses may be disposed on the battery housing 105. Corresponding extensions may be spring loaded to allow the battery pack 100 to be inserted by being depressed. When the battery pack 100 is fully received by the electronic device, the extensions may protrude into the recesses. The locking mechanisms may be electrical. For example, a solenoid may be used to securely hold the battery pack 100 in the recess 210. The locking mechanisms may be a combination of mechanical and electrical.

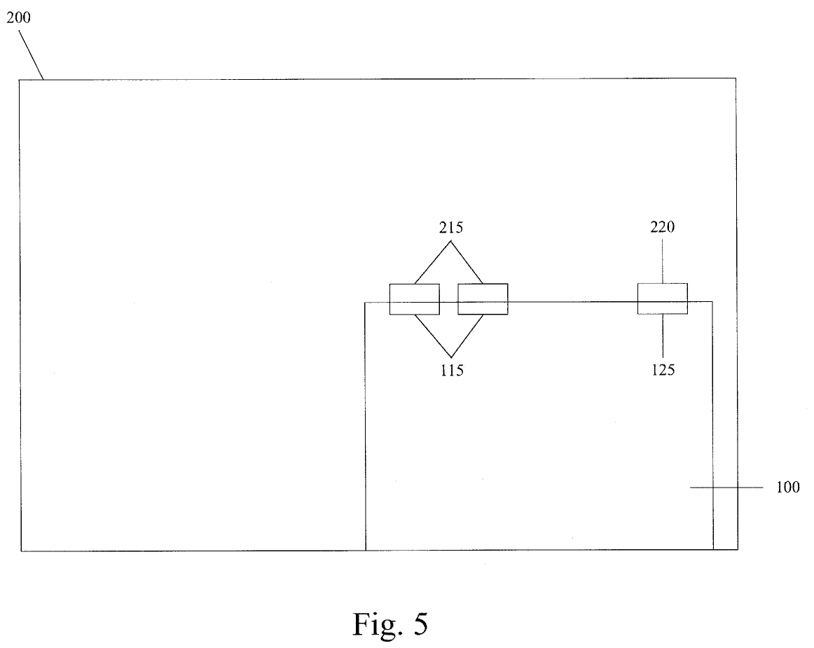

FIG. 5 shows an assembled view of the electronic device 200 of FIG. 3 upon receiving the battery pack 100 of FIG. 1. As described above, the cell contacts 115 may couple to the corresponding cell contacts 215 while the supercap contact 125 may couple to the corresponding supercap contact 220. In the assembled view, the recess 210 may have fully received the battery pack 100. The battery pack 100 may fill the window created by the recess 210. The battery housing 105 may create a flush surface with the device housing 205.

As discussed above, the supercap 120 may provide additional power for the electronic device so that high yields of energy may be used for various applications. Those skilled in the art will understand that certain applications of an electronic device may require a higher amount of energy. The supercap 120 may provide the additional energy required so that the cells 110 are not unduly discharged earlier than intended. The placement of the supercap 120 within the battery housing 105 may alleviate additional space required in the device housing 205. Consequently, the electronic device 200 may be designed more compactly. Furthermore, a printed circuit board (PCB) of the electronic device may be alleviated from the requirement that the supercap 120 be disposed thereon.

It should be noted that the supercap 120 being disposed within the battery housing 105 allows for a uniform design with respect to the electronic device. For example, electronic devices of a common product family may or may not include the applications that require high energy consumption. Thus, a different design is required to produce both types of electronic devices. However, through moving the supercap 120 to the battery pack 100, a uniform design for the electronic device may be used. Furthermore, a relatively cheaper alternative design for the battery pack may be used. The electronic device may receive either type of battery pack (e.g., including a supercap, excluding a supercap).

It should also be noted that replacement of supercaps may be performed more easily and efficiently through moving the supercap 120 to the battery pack 100. That is, when the supercap is disposed on the PCB, removal may require special tools and procedures such as removing solder that holds the supercap on the PCB. As a result, damage may be caused to other components of the electronic device, particularly the components already disposed on the PCB.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A battery pack, comprising:
a housing;
at least one cell disposed in the housing and providing power to an electronic device; and
a supercapacitor disposed in the housing and providing additional power to the electronic device.

2. The battery pack of claim 1, wherein the battery pack includes a plurality of cells.

3. The battery pack of claim 1, wherein the at least one cell is one of a nickel cadmium cell, a nickel hydride cell, and a lithium ion cell.

4. The battery pack of claim 1, wherein the at least one cell is electrically connected to a cell contact.

5. The battery pack of claim 4, wherein the cell contact is separated from a corresponding cell contact of the electronic device by at least one of a safety circuit and an intermediate contact.

6. The battery pack of claim 4, wherein the cell contact electrically couples to a corresponding cell contact of the electronic device.

7. The battery pack of claim 1, wherein the supercapacitor is electrically connected to a supercapacitor contact.

8. The battery pack of claim 7, wherein the supercapacitor contact is disposed on a periphery of the housing.

9. The battery pack of claim 7, wherein the supercapacitor contact electrically couples to a corresponding supercapacitor contact of the electronic device.

10. The battery pack of claim 1, wherein the plurality of cells and the supercapacitor are electrically isolated from each other.

11. The battery pack of claim 10, further comprising:
a divider disposed in the housing between the plurality of cells and the supercapacitor.

12. A system, comprising:
an electronic device including a recess; and
a battery pack to be received in the recess, the battery pack including a housing that houses at least one cell which provides power to the electronic device and a supercapacitor that provides additional power to the electronic device.

13. The system of claim 12, wherein the recess is at least partially disposed within the electronic device, the recess including an angled window to receive the battery pack.

14. The system of claim 12, wherein the recess is at least partially disposed within the electronic device, the recess including a slot to receive the battery pack.

15. The system of claim 12, wherein the recess is wholly disposed within the electronic device, the electronic device being opened to access the recess.

16. The system of claim 12, wherein the battery pack further comprises rails disposed on the housing to facilitate reception of the battery pack.

17. The system of claim 16, wherein the recess further comprises channels that receive the rails.

18. The system of claim 12, wherein the battery pack further comprises a cell contact electrically connected to the at least one cell and a supercapacitor contact electrically connected to the supercapacitor.

19. The system of claim 18, wherein the electronic device further comprises a corresponding cell contact that couples to the cell contact and a corresponding supercapacitor contact that couples to the supercapacitor contact, the corresponding cell contact and the corresponding supercapacitor contact being disposed within the recess.

20. A battery pack, comprising:
a housing;
a first power supplying means for providing power to an electronic device; and
a second power supplying means for providing additional power to the electronic device, the first and second power supplying means being disposed in the housing.
